(19) United States
(12) Patent Application Publication
(10) Pub. No.: US 2014/0011684 A1
(43) Pub. Date: Jan. 9, 2014

(54) SUPERCONDUCTOR TRANSMISSION LINES HAVING JOINT LN2 AND THERMOELECTRIC COOLING

(71) Applicant: NEIL ROBERT JETTER, PALM BEACH GARDENS, FL (US)

(72) Inventor: NEIL ROBERT JETTER, PALM BEACH GARDENS, FL (US)

(21) Appl. No.: 13/931,335

(22) Filed: Jun. 28, 2013

Related U.S. Application Data
(63) Continuation of application No. 12/752,811, filed on Apr. 1, 2010, now abandoned.

(51) Int. Cl. H01B 12/16

(52) U.S. Cl. CPC H01B 12/16
USPC 505/163; 174/15.5

(57) ABSTRACT

A high temperature superconductor (HTS) transmission line for transporting electricity includes a plurality of HTS wires coupled to receive and transport electricity. A cooling system is thermally coupled by a thermally conductive coupling material to the plurality of HTS wires and includes a plurality of joint coaxial cooling arrangements each including a thermoelectric (TE) cooler radially outside a inner liquid nitrogen (LN2) cooler. The TE coolers are powered by electricity flowing along the plurality of HTS wires. The TE cooler cools the outer portion of the joint coaxial cooling arrangement to an intermediate temperature that is above a target controlled temperature, and the LN2 cooler cools from the intermediate temperature to a temperature at or below the target controlled temperature.

### CROSS REFERENCE TO RELATED APPLICATIONS

This application is a continuation of U.S. non-provisional patent application Ser. No. 12/752,811 entitled “SUPERCONDUCTOR TRANSMISSION LINES HAVING JOINT LN2 AND THERMOELECTRIC COOLING AND REMOTE NUCLEAR POWER SYSTEMS THEREFROM” filed on Apr. 1, 2010, which is hereby incorporated by reference in its entirety into this application.

### FIELD

Disclosed embodiments relate to superconductors, and transmission of electricity therethrough.

### BACKGROUND

Superconducting wire is wire made of superconductors. When cooled below its transition temperature, it has essentially zero electrical resistance. One application for superconducting wire is for transmitting electricity.

Nuclear power is a type of nuclear technology comprising the controlled use of nuclear reactions, usually nuclear fission, to release energy for performing work including propulsion, heat, and/or the generation of electricity. Nuclear energy is produced by a controlled nuclear chain reaction which creates heat which is generally used to boil water and produce steam that drives a steam turbine. The turbine can be used for mechanical work and also to generate electricity.

In nuclear fission, as known in the art, when a relatively large fissile atomic nucleus is struck by a neutron it forms two or more smaller nuclei as fission products, releasing energy and neutrons. The chain reaction is controlled through the use of materials that absorb and moderate neutrons. In uranium-fueled reactors, neutrons must be moderated (slowed down) because slow neutrons are more likely to cause fission when colliding with a fissionable materials such as uranium-235 nucleus. Light water reactors use ordinary water to moderate and cool the reactors. When at operating temperatures if the temperature of the water increases, its density drops, and fewer neutrons passing through it are slowed enough to trigger further reactions. The negative feedback produced stabilizes the reaction rate.

Proponents of nuclear energy argue that nuclear power is a sustainable energy source that reduces carbon emissions and increases energy security by decreasing dependence on foreign oil. Proponents also claim that the risks of storing waste are small and can be further reduced by the technology in the new reactors and the operational safety record is already good when compared to the other major kinds of power plants. However, critics claim that nuclear power is a potentially dangerous energy source. Critics also point to the problem of storing radioactive waste, the potential for possibly severe radioactive contamination of the area surrounding the nuclear plant by accident or sabotage (e.g., terrorism). The two most well-known nuclear accidents are the Three Mile Island accident and the Chernobyl disaster.

Nuclear power plants may have vulnerability to terrorist attack. However, nuclear power plants are generally (although not always) considered “hard” targets. In the U.S., nuclear plants are surrounded by a double row of tall fences which are electronically monitored. The plant grounds are patrolled by a sizeable force of armed guards. Attack from the air is a more problematic concern.

Although nuclear power is capable of supplying the majority of world power likely for at least the next 100 years, the risk of accident or terrorism at a nuclear power plant as well as the disposal of nuclear waste currently limits its use. Since conventional copper wire power distribution systems are only capable of distributing power from power plants on the order of several miles (even using high voltage transmission) due to resistive loss, power plants including nuclear reactors and their waste generated have always been located near the population center served by the plant. Accordingly, a significant obstacle to nuclear energy has generally been the presence of the nuclear reactor close to the community in which the power is needed.

### BRIEF DESCRIPTION OF THE DRAWINGS

FIG. 1 is a side sectional depiction of a portion of a power transmission system comprising a superconducting article and a plurality of thermoelectric (TE)-based cooling systems thermally coupled to the superconducting article for providing cryogenic cooling for the superconducting article, according to a disclosed embodiment.

FIG. 2 shows a block and side sectional depiction of a system comprising a nuclear power plant including a turbine for generating electricity, wherein the plant is positioned in a location remote from any population center, and includes the power transmission system depicted in FIG. 1, according to a disclosed embodiment.

FIG. 3 is a cross sectional depiction of a coaxial TE/liquid nitrogen (LN2) jointly cooled electrical power transmission system including a plurality of high temperature superconductor (HTS) wires according to a disclosed embodiment.

### DETAILED DESCRIPTION

Disclosed embodiments are described herein with reference to the attached figures, wherein like reference numerals are used throughout the figures to designate similar or equivalent elements. The figures are not drawn to scale and they are provided merely to illustrate certain disclosed features. Several disclosed aspects are described below with reference to example applications for illustration. It should be understood that numerous specific details, relationships, and methods are set forth to provide a full understanding of this Disclosure. One having ordinary skill in the relevant art, however, will readily recognize that subject matter disclosed herein can be practiced without one or more of the specific details or with other methods. In other instances, well-known structures or operations are not shown in detail to avoid obscuring details.

Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

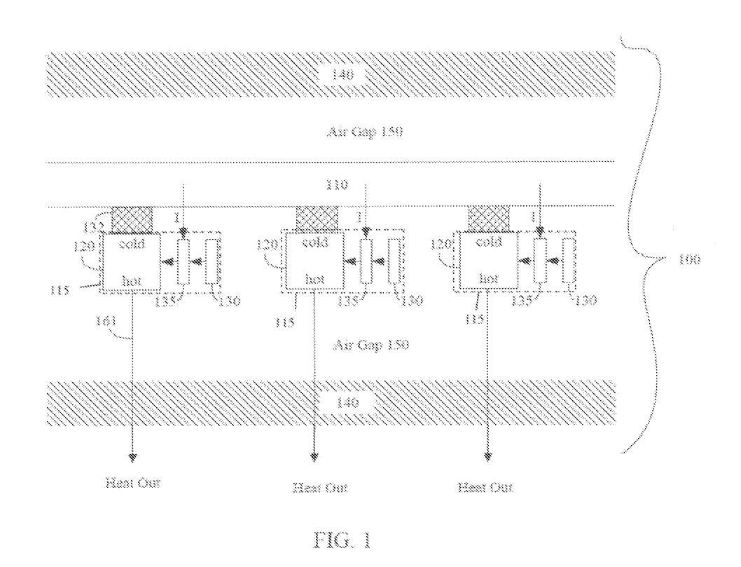

One disclosed embodiment is a power transmission system comprising a superconducting article and at least one, and generally a plurality of TE-based coolers, for providing cryogenic cooling to the superconducting article, such as superconducting wire. Referring to FIG. 1, a side sectional depiction of a portion of a power transmission system 100 comprising a superconducting article 110 and a plurality of TE-based cooling systems 115 each comprising TE coolers 120 thermally coupled by thermally conductive coupling material 132 to the superconducting article 110 for providing cryogenic cooling to the superconducting article 110, according to a disclosed embodiment, is shown. Superconducting article 110 is typically a superconducting wire comprising article, such as a multi-wire HTS transmission cable. Although not shown, as known in the art, superconducting article 110 includes a stabilizer metal (e.g., Cu mesh) which provides high electrical conductivity for the superconducting article 110 even at room temperature for mitigating the effects of local current disruptions.

As known in the art of superconductors, superconductors require cooling to near liquid nitrogen temperatures to provide their superconducting properties. High-temperature superconductors (abbreviated high Tc) are a family of superconducting materials containing copper-oxide planes as a common structural feature. This feature allows some materials to support superconductivity at temperatures above the boiling point of liquid nitrogen (77 K or −196° C.).

Yttrium barium copper oxide, often abbreviated YBCO, is a crystalline chemical compound with the formula YBa₂Cu₃O₇. YBCO provides superconductivity above the boiling point of nitrogen, down to about 92 K, which is significant because liquid nitrogen (LN2) can be used as a refrigerant (at atmospheric pressure, the boiling point of nitrogen is 77 K). As known in the art, LN2 can be produced inexpensively on-site from the air. Moreover, LN2 is a compact and readily transported source of nitrogen gas without pressurization.

As known in the art, the superconducting article 110 embodied as a HTS transmission line can comprise a plurality of individual HTS cables running in parallel, containing ribbon-shaped HTS wires. As known in the art, such HTS wires when cooled to be superconductive can conduct about 150 times the electricity of similar sized copper wires, using much lower voltage than copper. Disclosed embodiments can utilize other HTS wire embodiments.

The TE-based cooling systems 115 each include a temperature sensor 130 located proximate to the superconducting article 110 that senses the temperature of the portion of the superconductor article 110 served. The TE-based cooling systems also include a temperature sensor 130 that outputs a signal based on the measured temperature that actuates a dedicated switch 135 that directs current (I) from the superconducting article 110 to its dedicated TE cooler 120 when cooling is needed by the particular portion of the superconductor article 110 to remain below a predetermined temperature. There is generally no need for a current limiting device to limit the current from superconducting article 110 to the TE cooler 120 during steady state operation, such as due to the current divider rule known in basic electronics based on the electrical resistance of the respective materials themselves (resistance of the TE cooler 120>>resistance of the superconductor article 110).

Cooling can thus be applied automatically and intermittently to the respective portions of the superconductor article 110 on an as-needed basis, such as to maintain the superconducting article 110 below a predetermined temperature, such as about 85 K. Conveniently, the electrical energy to power the thermoelectric coolers 120 can be supplied by electricity transmitted along superconducting article 110 (e.g., HTS wires).

A thermally insulating isolation structure 140 thermally isolates system 100 from the ambient. An air gap 150 is shown between superconducting article 110 and thermally insulating isolation structure 140. As described below, thermally insulating isolation structure 140 can comprise ice, with a porous thermal insulator such as snow thereon in one embodiment. A thermally conductive conduit 161 is shown coupled to the hot side of the TE coolers 120 for conducting heat away from system 100 by transmitting the heat outside of thermally insulating isolation structure 140 as shown in FIG. 1.

The TE-based cooling systems 115 thus provide cooling without a working fluid to ensure the superconducting article 110 is held at a temperature low enough so that superconducting properties are provided along the entire length of the superconducting article 110. In the steady state, the current to power the TE coolers 120 can generally by obtained from current by conducted by the superconducting article, thus significantly reducing the need for conventional LN2 cooling which requires continuous flow of LN2. Embodiments for overcoming start-up issues associated with the temperature of the HTS wire beginning above the critical superconductor temperature are described below.

TE coolers 120 are well known and are sold commercially. Although not widely recognized, TE coolers can provide cooling to obtain cryogenic temperatures from conventional ambient conditions. For example, U.S. Pat. No. 6,505,468 (the '468 application) discloses a cascade thermoelectric cooler comprising a plurality of thermoelectric coolers cascaded in series to cool to cryogenic temperatures of 30 to 120 K without the need for LN2. The '468 application is hereby incorporated by reference into this application.

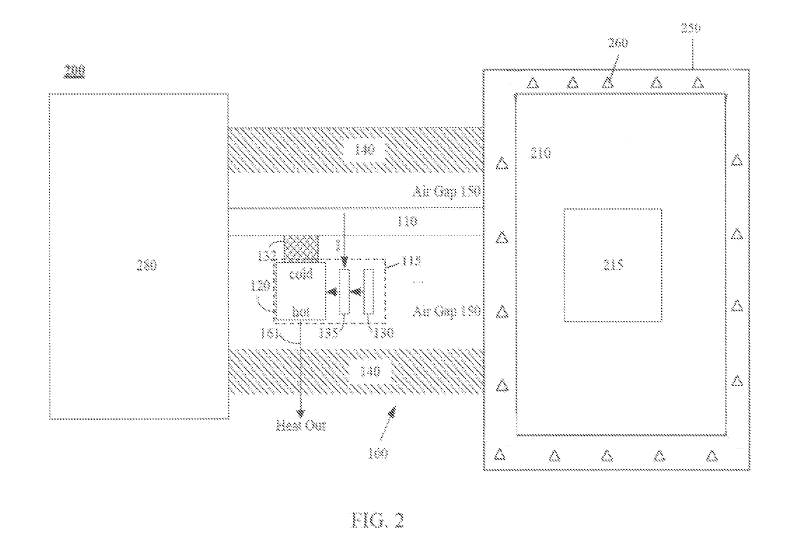

Another disclosed embodiment provides a nuclear plant and a power transmission system described above that can largely overcome the geographic proximity problem to allow nuclear power to begin supplying a significant portion of world's power needs, if not the majority of its needs. FIG. 2 shows a block and side sectional depiction of a power generation and power distribution system 200 according to another disclosed embodiment.

System 200 comprises a nuclear power plant 210 including a turbine 215 for generating electricity, wherein the plant is positioned in a remote location from any population center, that is generally at least 10 miles and is typically at least 50 miles away. The nuclear plant 210 can generally be any type of nuclear plant. System 200 is shown including the power transmission system 100 shown in FIG. 1, and a user of said electricity or a system for generating an energy form from the electricity shown as system 280 for generating a different energy form from electricity from the electricity generated by nuclear power plant 210 and transmitted by superconductor article 110. The power can then be used by a system 280 for generating another energy to generate a fuel, such as hydrogen (e.g. from water, such as by electrolysis) which can be piped over long distances analogous to how natural gas and propane are transported currently.

As described above, superconducting article 110 comprising HTS wire is coupled to receive and transport the electricity generated at the plant at least a portion of the distance between the plant location and a user of the electricity provided by nuclear power plant 210. In one embodiment, the location comprises Antarctica or the arctic, or a location near the arctic circle, so that the thermally insulating isolation structure 140 comprises ice. For example, in the U.S., many locations in the state of Alaska may generally be used, or a good portion of northern Canada.

System 200 is also shown including a military installation 250 surrounding the nuclear power plant 210. Military installation 250 is shown having armaments 260 for repelling enemy attacks from both the air and the ground.

The thermoelectric converting efficiency (TCE) is known to be a temperature dependent parameter. The Inventor has recognized that most materials experience a significant reduction in TCE as the temperature is decreased to low temperatures, such as between 100 K and 150 K. Since YBCO and related superconductors require a temperature of 90K or less to provide superconductivity, HTS cooling is needed to generally reach a temperature that is below 100 K. Although some materials are known that provide a reasonable TCE below 100 K, including below 77K, such materials are generally Tellurium-comprising which can significantly raise the cost of the TE coolers and thus the cost of implementation a TCE-based cooling system. Such Tellurium-comprising materials can include compounds such as Bᵢ₂Tₑ₃, Bᵢ₂S_{b8}Tₑ₁₅, BiTₑ₂Se and PbTe.

In another disclosed embodiment, TE coolers are combined with LN2 coolers by using a joint coaxial TE/LN2 cooling arrangement. In the joint coaxial cooling arrangement, the TE cooling cools the outer portion of the coaxial cooling arrangement to an intermediate temperature that is above the target controlled temperature, while the LN2 cooler is used to cool from the intermediate temperature to a temperature at or below the target controlled temperature (e.g. 85 K).

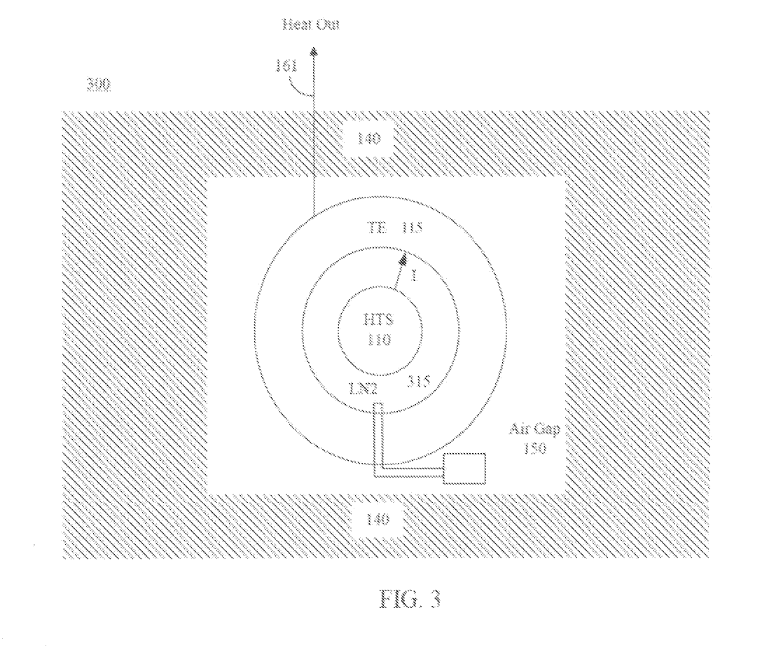

FIG. 3 is a cross sectional depiction of a joint coaxial TE/LN2 cooled electrical power transmission system 300 including a HTS transmission line comprising a plurality of HTS wires according to a disclosed embodiment. In the joint coaxial cooling arrangement shown in FIG. 3 the TE-based cooling system 115 electrical current I from the superconductor article shown as HTS wires 110 sufficient to provide cooling for the joint coaxial cooling arrangement to an intermediate temperature that is above a target controlled temperature, such as between 100 to 150K. The inside portion of the coaxial cooling arrangement includes an LN2 cooled flow channel 315 (LN2 cooler) upon which LN2 from LN2 generator 318 provides cooling from the intermediate temperature to the target controlled temperature, such as to 80 to 85 K.

Since the LN2 generator 318/cooler 315 only needs to provide cooling of about 50 K from the intermediate temperature, the amount of LN2 needed during steady-state operation of system 300 is clearly only a small fraction of the amount of LN2 needed by a conventional superconductor power transmission arrangement to cool from ambient temperate to the target controlled temperature.

In addition, the LN2 generator 318/cooler 315 can be used for start-up to cool the HTS wire 110 to initially reach the target controlled temperature. Start up is generally needed because conventional HTS wire cannot generally be used provide current to the TE coolers until the critical temperate is reached. In one embodiment, a sufficient length of conventional power transmission line is used together with the TE devices to ensure reaching the target controlled temperature before the HTS wire is reached. In another embodiment, the stabilizer metal (e.g., Cu mesh) of the superconducting article 110 itself is used to provide current to the TE devices. In yet another embodiment, a conventional power transmission line is used in parallel to the HTS wire to allow the HTS wire to be automatically switched on when the critical temperature for the HTS is reached.

Recent superconductor technology advances have provided relatively low cost, high quality superconducting wire based electrical transmission lines with the proven capability transmit electricity almost one mile, with the capability to scale to span tens or hundreds of miles. For example, in it was reported in 2008 that a 2,000-foot (about 4/10 of a mile) long superconducting cable, made with HTS wire produced by American Superconductor Corporation Devens, Mass., was installed in Holbrook, N.Y. The HTS wire was installed underground and was chilled exclusively with LN2 to minimize power loss in the transmission lines. The Long Island Power Authority has already begun utilizing the 138 kvolt system, which is able to handle 574 megawatts of power, according to American Superconductor. It was asserted that “The entire power output of a traditional coal-fired or gas-fired or nuclear power plant could flow through this one cable.”

By positioning nuclear power plants in desolate locations uninhabited by humans, such as in arctic and Antarctic regions, deserts, or even portions of certain oceans, the electricity generated by the power plant can be provided to distant locations for consumption by superconducting wires which can supply power long distances with relatively modest resistive losses. Locating nuclear plants in desolate locations provides the ability to fortify the plant to prevent terrorist incursion and also provide a convenient location for storing spent fuel on site.

One significant advantage of locating the nuclear plant in an arctic or Antarctic location, or a near arctic location such as some locations in Alaska or Canada, is that the very low ambient temperature reduces the challenge of maintaining the required low temperature (e.g., ≦100 to 120 K for currently available HTS). Average January temperatures in the arctic generally range from about −40 to 0° C., and winter temperatures can drop below −50° C. over large parts of the Arctic. Average July temperatures in the arctic range from about −10 to +10° C. For example, assuming a nominal arctic or Antarctic temperature of −10° C. (263K) the cooling requirement (ΔK=Δ° C.) for currently available HTS would be 143 to 163 K. In contrast, a typical temperate location may be around 27° C. (300 K), making the cooling requirement (ΔK) for currently available HTS be 180 to 200 K. In one embodiment, the power transmission system including the superconducting wires are located above the ground analogous to conventional above the grounds power distribution systems. As disclosed above, in one embodiment the power transmission system including the superconducting wires may be positioned under the ice, which may assist in maintaining a low temperature particularly during the summer months.

As disclosed above, the electricity generated at the plant and carried by the power transmission system can be converted to another energy form before reaching the user. For example, in one embodiment, electricity is used to generate hydrogen gas (H₂) from water using electricity (by electrolysis). Conventional electrolysis is a low temperature process. In contrast with low-temperature electrolysis, high-temperature electrolysis (HTE) electrolysis of water converts more of the initial heat energy into chemical energy (hydrogen), potentially doubling efficiency, to about 50%. Because some of the energy in HTE is supplied in the form of heat, less of the energy must be converted twice (from heat to electricity, and then to chemical form), and so less energy is lost. HTE has been demonstrated in laboratories, but not yet at a commercial scale. Once generated, hydrogen does not require cooling. The hydrogen could then by piped analogous to how natural gas or propane and other parts of the world today.

In one particular embodiment, a plurality of fuel generation plants can surround the nuclear plant, such as at a distance of 10 to 50 miles, and located along a circle (or more generally an ellipse) at zero degrees, 90 degrees, 180 degrees and 270 degree position relative to the nuclear plant. As disclosed above, defense establishments may be co-located with the fuel generation plants to secure the fuel generation plants as well as the nuclear plant at the center of the arrangement from threats including terrorist attacks.

Disclosed embodiments can be embodied in other forms without departing from the spirit or essential attributes thereof and, accordingly, reference should be had to the following claims rather than the foregoing specification as indicating the scope of this Disclosure.

In the preceding description, certain details are set forth in conjunction with the described embodiment to provide a sufficient understanding of the subject matter disclosed herein. One skilled in the art will appreciate, however, that the disclosed embodiments may be practiced without these particular details. Furthermore, one skilled in the art will appreciate that the example embodiments described above do not limit the scope of this Disclosure and will also understand that various modifications, equivalents, and combinations of the disclosed embodiments and components of such embodiments are within the scope of this Disclosure. Moreover, embodiments including fewer than all the components of any of the respective described embodiments may also within the scope of this Disclosure, although not expressly described in detail. Finally, the operation of well known components and/or processes has not been shown or described in detail below to avoid unnecessarily obscuring disclosed feature.

One skilled in the art will understood that even though various embodiments and advantages of such embodiments in the Disclosure have been set forth in the foregoing description, the above disclosure is illustrative only, and changes may be made in detail, and yet remain within the broad principles of this Disclosure.

1. A high temperature superconductor (HTS) transmission line for transporting electricity, comprising:
a plurality of HTS wires coupled to receive and transport said electricity, and
a cooling system thermally coupled by a thermally conductive coupling material to said plurality of HTS wires comprising a plurality of joint coaxial cooling arrangements,
wherein said joint coaxial cooling arrangements each include a thermoelectric (TE)-based cooler radially outside an inner liquid nitrogen (LN2) cooler, and
wherein said TE-based coolers are powered by said electricity flowing along said plurality of HTS wires.

2. The HTS transmission line of claim 1, wherein said TE-based coolers further comprise a plurality of temperature sensors disposed proximate to said plurality of HTS wires, and a switch, and wherein a signal from said temperature sensors is for controlling a flow of current from said plurality of HTS wires supplied to respective ones of said TE-based coolers.

3. The HTS transmission line of claim 1, wherein said TE-based coolers provide cooling for said joint coaxial cooling arrangements to an intermediate temperature that is above a target controlled temperature, and wherein said LN2 cooler cools from said intermediate temperature to a temperature at or below said target controlled temperature.

4. The HTS transmission line of claim 3, wherein said intermediate temperature is in a range from 100K to 150K.

5. The HTS transmission line of claim 1, wherein said electricity is generated by a nuclear power plant including a turbine.

6. The HTS transmission line of claim 5, further comprising a system for converting electrical energy to a fuel coupled to receive said electricity from said HTS transmission line.

7. The HTS transmission line of claim 6, wherein said fuel is hydrogen, and said HTS transmission line is at least 10 miles in length.

8. The HTS transmission line of claim 1, wherein said HTS transmission line is located underground.
